(19) United States
(12) Patent Application Publication
(10) Pub. No.: US 2007/0102626 A1
(43) Pub. Date: May 10, 2007

(54) Displacement and velocity sensor

(76) Inventor: J. Doss Halsey, Severna Park, MD (US)

Correspondence Address: NEIL K. NYDEGGER;NYDEGGER & ASSOCIATES, 348 Olive Street, San Diego, CA, 92103, US

(21) Appl. No.: 11/270,009

(22) Filed: Nov. 9, 2005

(51) Int. Cl. H01J 40/14

(52) U.S. Cl. 250/221

(57) ABSTRACT

A sensor system that is attachable to a moving object to calculate a displacement of the object relative to a fixed surface includes three laser light sources. The sources are fixedly aligned to direct beams along three respective beam paths toward the surface. Reflections from the surface are then received by the sensor system and used to calculate a relative velocity between the sensor and surface. The velocity is then integrated to compute a displacement. These displacements are transmitted via wireless link to a receiving station which uses the displacements to track and locate the object.

### FIELD OF THE INVENTION

The present invention pertains generally to an on-board sensor for measuring the displacements of a moving object. More particularly, the present invention pertains to a sensor that can be attached to an individual to track the individual's movements. The present invention is particularly, but not exclusively, useful for determining the location of an individual such as a firefighter or soldier who has entered a structure or an area inside which GPS or other navigation systems no longer work.

### BACKGROUND OF THE INVENTION

Soldiers of the future will require accurate indoor navigation for situational awareness, for coordinating sweeps of buildings, and for rescue operations for downed troops. Firefighters and rescue workers have similar needs for indoor navigation. Every year approximately 100 firefighters die in the line of duty, approximately 20% of them from being lost or trapped. RIT teams (Rapid Insertion Teams) are sent in to rescue the downed firefighter. These teams would greatly benefit from knowledge of where in the building the downed firefighter is located and the path he took to get there.

Radio navigation, however, is problematic in and around buildings. For example, GPS does not work very well indoors due to low signal penetration as well as propagation perturbations caused by the presence of structural steel and electrical wiring in buildings. In addition, inertial navigation techniques also fail to provide a complete solution to the problem of indoor navigation. Although some inertial systems may be capable of the accuracy needed over timelines of operational significance, these systems are far too bulky and expensive for use on individual soldiers or firefighters.

The approach considered here, on the other hand, involves a sensor that tracks the indoor surfaces to continuously determine and update the location of a person wearing the sensor. This location information can then be sent to other soldiers or commanders for use on situational awareness displays via a wireless network. For rescue operations, the geolocation accuracy necessary to find a downed individual is typically calculated based on the radius of effectiveness of a man with outstretched arms and legs. This generally equates to a circular error probability (CEP) of approximately two meters. In the case of a fire, smoke is often so thick as to preclude any visual clues. In these instances, finding a downed firefighter may result only from actually touching him.

In light of the above, it is an object of the present invention to provide systems and methods for accurately measuring the movements of an individual and processing the measurements to determine the current location of the individual. It is another object of the present invention to provide a system for accurately tracking the indoor movements of an individual by measuring the individual's velocity. It is yet another object of the present invention to provide a lightweight, wearable sensor for determining an individual's velocity and displacement. Yet another object of the present invention is to provide a velocity and displacement sensor which is easy to use, relatively simple to implement, and comparatively cost effective.

### SUMMARY OF THE PREFERRED EMBODIMENTS

The present invention is directed to a sensor system for calculating a displacement of an object relative to a surface. For example, the sensor system can be attached to a movable object such as an individual to track the individual's movements within a building. Information regarding the individual's movements and location can then be relayed by wireless link to a receiving station which is typically located outside the building.

In greater structural detail, a typical embodiment of the sensor system includes three laser light sources for generating and directing three laser light beams along three respective beam paths. For the sensor system, the three beam paths are maintained at a constant spatial relationship relative to each other. Moreover, the sensor system is attached to the object to direct each outgoing light beam toward a selected surface of the building such as the floor. There, at the surface, each beam is reflected back toward the sensor to produce an incoming beam on each beam path.

To receive and process each incoming beam, the sensor system includes a means for coherently detecting the reflected light for each beam path. For example, a homodyne detection scheme uses a sample of the light sent and beats the reflected signal against the sample on a detector. Functionally, in the context of the present invention, for each beam path, a detector and mixer interact to measure 1) a respective distance between the sensor and surface along the beam path, and 2) a respective frequency difference between the incoming and outgoing light beams (i.e. Doppler shift). From these measurements, the x, y and z components of a displacement vector for the object relative to the surface can be calculated. In greater detail, the measured distances are processed to determine an orientation of the beam paths relative to the surface. With the orientation known, the measured frequency difference for each beam path can be converted into a velocity vector having x and y components that lie in the plane of the surface. The processor then integrates the velocity vector to compute x and y displacement vector coordinates. A component in the z direction (i.e. sensor height) can also be calculated using the distance measurements.

In one application, the sensor system is configured for attachment to the outer portion of a boot at an attachment location near the top rear of the boot. For this application, three laser beams are directed downwardly toward the ground, with each beam path being inclined at an acute angle relative to another beam path. The sensor system is then initialized at a predetermined building location which, for example, can be an entrance to a building the individual is entering.

Once initialized, the sensor system acquires and records data corresponding to the frequency differentials and sensor/surface distances for each beam path. Specifically, the data is passed to a processor which completes the computation described above to compute the components of a displacement vector. A wireless link is established between the sensor system and a receiving station which is typically located outside the building. The displacements can then be accumulated at the receiving station and used to maintain a real-time location for the individual inside the building. It is to be appreciated that selected portions of the processing, or all of the processing, can be accomplished by a processor that is attached either to the individual or is located at the receiving station.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a sensor system for determining displacements of a moving object relative to a fixed surface shown attached to a firemen's boot and positioned inside a building;

FIG. 2 is a schematic layout of a sensor system showing electrical connections and beam paths for one of three lasers that are provided in the sensor system shown in FIG. 1; and

FIG. 3 is a schematic diagram illustrating a coordinate translation for translating range and Doppler measurements along the sensor system's beam axes to an inertial x-y coordinate system wherein the x and y dimensions lie in a plane defined by a fixed surface (e.g. a floor) over which the sensor system travels.

### DESCRIPTION OF THE PREFERRED EMBODIMENT

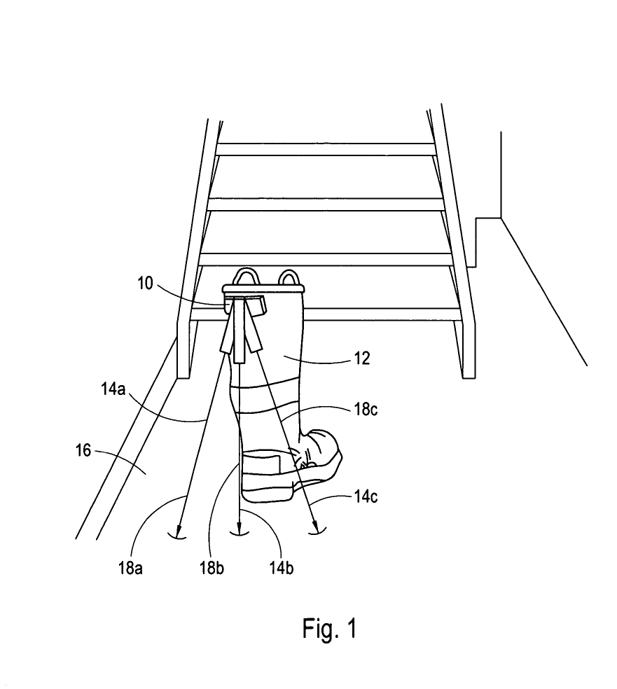

Referring to FIG. 1, a sensor system 10 for determining displacements of a moving object relative to a fixed surface is shown. For the application shown in FIG. 1, the sensor system 10 is shown attached to the outer portion of a firemen's boot 12 at a location near the top rear of the boot 12. In addition to tracking firefighters, other applications of the sensor system 10 include, but are not limited to, tracking soldiers that have entered buildings, tracking the locations of vehicles inside or outside buildings, and in general, is applicable to tracking the location of moveable objects relative to a fixed surface.

For the sensor system 10, three laser beams 14a-c are directed downwardly toward a surface 16, which in this case is the floor, along respective beam paths 18a-c. FIG. 1 further shows that each beam path 18a-c is inclined at an acute angle relative to the other beam paths 18a-c (i.e. the beam paths 18a-c are not parallel).

Continuing with reference to FIG. 1, for the sensor system 10, the three beam paths 18a-c are maintained at a constant spatial relationship relative to each other. Moreover, FIG. 1 shows that each laser beam 14a-c is reflected at the surface 16 and a portion of each reflection is directed back toward the sensor 10 along the respective beam paths 18a-c. In functional overview, the sensor system 10 receives and processes each reflected beam 14a-c as the boot 12 moves relative to the surface 16 to calculate relative displacements between the boot 12 and surface 16.

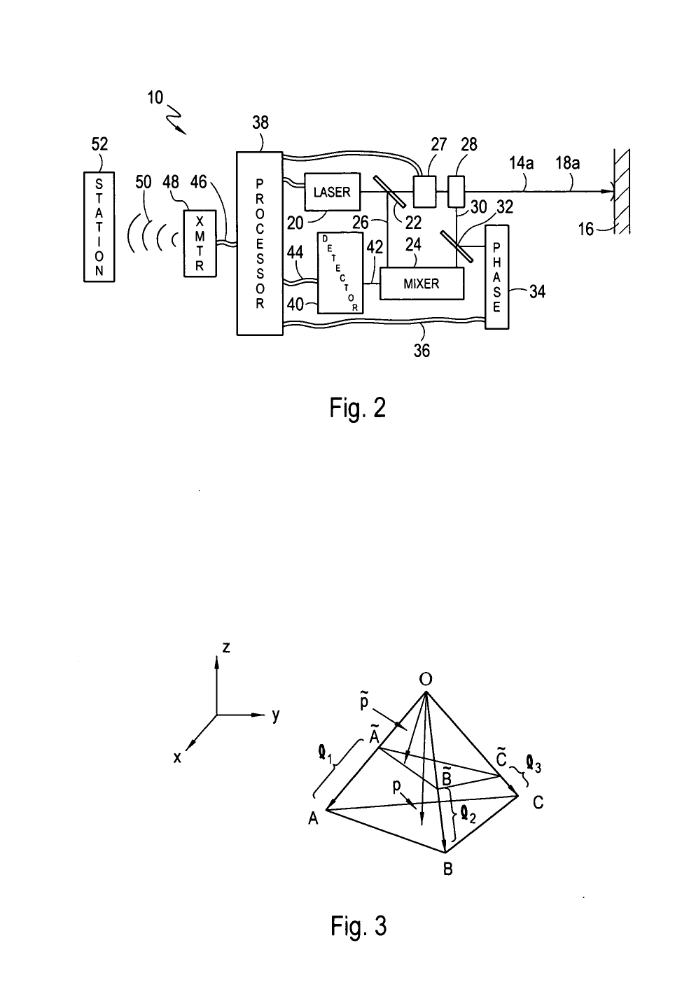

FIG. 2 shows a portion of the sensor system 10 for beam path 18a in further detail. It is to be appreciated the similar components can be included for beam paths 18b and 18c shown in FIG. 1. As shown in FIG. 2, the sensor system 10 includes a laser source 20 which is configured to emit a laser beam 14a along beam path 18a. As described in further detail below, a splitter 22 is provided to direct a portion of the laser beam 14a to a mixer 24 along beam path 26. As shown, the remaining portion of the beam 14a is directed from the splitter 22 to a modulator 27 which modulates the laser beam 14a with a continuous wave modulation. From the modulator 27, the beam 14a passes through receive optics 28 and reaches the targeted surface 16 along beam path 18a. Reflections from the surface 16 then travel back along beam path 18a to the receive optics 28 where the reflections are diverted onto beam path 30. For the sensor system 10, the receive optics 28 can include, but is not limited to, one or more of the following optical components: splitters, filters, mirrors and lenses.

Continuing with reference to FIG. 2, once on beam path 30, light reflected from surface 16 is partitioned at splitter 32, as shown. Specifically, one portion is directed from the splitter 32 to a phase measuring circuit 34 and the remaining portion passes through splitter 32 and is input into mixer 24, as shown. At the phase measuring circuit 34, the phase of the reflected modulated signal is measured relative to the CW modulation leaving the modulator 27. The relative phase is then sent via cable 36 to the processor 38 to determine a distance between the sensor system 10 and the surface 16 along beam path 18a. In one implementation, a modulation signal wavelength is selected to be larger than the measured distance to obviate modulo 2π ambiguities. In an alternate embodiment (not shown), a pulsed laser beam can be used to determine the distance between the sensor system 10 and the surface 16 along beam path 18a in accordance with procedures and system components known in the pertinent art.

FIG. 2 further shows that the mixer 24 is in optical communication with a photodetector 40 along beam path 42. Functionally, the detector 40 and mixer 24 interact to measure a respective frequency difference between the reflected light on beam path 30 and the unreflected light on beam path 26. (i.e. Doppler shift). In one setup, the light on paths 26 and 30 is combined by the mixer 24 and beat against the photodetector 40. The output of the photodetector 40 is then forwarded to the processor 38 via cable 44 which determines the frequency difference between the light on paths 26 and 30. As detailed further below, once the processor 38 has acquired 1) the frequency difference between the light on paths 26 and 30, and 2) the distances between the sensor system 10 and the surface 16 along beam paths 18a-c, the processor 38 computes the displacements of the sensor system 10 relative to the surface 16. These displacements can then be sent via cable 46 to a transmitter 48 which sends a wireless signal 50 that includes displacement information to one or more receiving stations 52. In addition to, or in lieu of, displacement information, the processor 38 can calculate an actual position (e.g. coordinates in a coordinate system similar to GPS coordinates) for wireless transmission to a receiving station 52. The receiving station 52 can be carried by another firefighter who is located inside or outside the building.

Referring back to FIG. 1, for the sensor system 10, the x, y and z components of a displacement vector for the movements of the boot 12 relative to the surface 16 can be calculated. More specifically, the measured distances between the sensor system 10 and surface 16 along the beam paths 18a-c are processed to determine an orientation of the sensor system 10 relative to the surface 16. In greater detail, this task is conducted to assess the impact of errors in range and Doppler measurement by the sensor system 10 on position accuracy in the inertial frame (i.e. x and y coordinates along the floor). To accomplish this error assessment, the range and Doppler measurements are translated along the beam axes (i.e. beam paths 18a-c) in the sensor frame of reference to the inertial frame (i.e. x and y coordinates along the floor). In this way, the sensor system 10 measures the coordinate tilt by measuring the distance to the floor in the directions of the three beam paths 18a-c. The required coordinate change is given by computing a rotation matrix for the coordinate tilt.

FIG. 3 illustrates the coordinate tilt. The triangle Ã \tilde{B} \tilde{C} represents the plane of the sole of a boot 12. The vector \tilde{p} denotes an orthogonal vector from point O to the bottom of the boot 12. For the illustration shown, the triangle A B C is considered to be in the plane of the floor. The vector p denotes an orthogonal vector from the point O to the bottom of the boot 12 in this case.

From FIG. 3 it can be seen that the frame rotation matrix is defined by the vector:

$$ω = \frac{p}{‖ p ‖} \times \frac{\tilde{p}}{‖ \tilde{p} ‖} \qquad ( 1 )$$

With this equation, l₁, l₂, and l₃ can be used to denote the measured distances in the three directions. In addition, three vectors of unit length can be defined in the direction of \vec{OA}, \vec{OB}, and \vec{OC}. It can be further assumed that the length of \vec{OA}, \vec{OB}, and \vec{OC} is l₀. It follows that the vectors of {right arrow over (OÃ, \vec{O\tilde{B}}, and \vec{O\tilde{C}} are given by:
{right arrow over (OÃ=(l₀−l₁)u₁, \vec{O\tilde{B}}=(l₀−l₂)u₂, \vec{O\tilde{C}}=(l₀−l₃)u₃. (2)
The orthogonal vector \tilde{p} can be computed as:
\tilde{p}=ũ₁+ã(ũ₂−ũ₁)+\tilde{b}(ũ₃−ũ₁) (3)
where the symbol ũₖ=(lₖ−l₀)uₖ, k=1, 2, 3 is used for simplicity of notation. The coefficients ã and \tilde{b} can be computed from the conditions that \tilde{p} is orthogonal to (ũ₂−ũ₁) and (ũ₃−ũ₁). The vector p can be computed by replacing ũₖ with uₖ in Eq. (2). The rotation vector ω is projected in the directions of the x, y, and z axes in the inertial frame to define the coordinate transformation matrix in the x, y, and z directions.

With the orientation known, the measured frequency difference for each beam path 18a-c can be converted into a velocity vector having x and y components that lie in the plane of the surface 16. The processor 38 shown in FIG. 2 then integrates the velocity vector to compute x and y displacement vector coordinates. A displacement component in the z direction can be calculated directly from the distance measurements.

While the particular displacement and velocity sensor as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A sensor system for calculating a displacement of a sensor relative to a surface, the sensor system comprising:
at least one light source for directing a plurality of light beams along a plurality of respective beam paths toward the surface for reflection therefrom;
a means for maintaining a substantially constant spatial relationship between the beam paths;
a means for operating on reflected light for each beam path to measure a respective distance between the surface and the sensor for each beam path;
a means for receiving reflected light for each beam path to determine a respective velocity between the surface and the sensor for each beam path; and
a means for processing the velocities and the distances to calculate a sensor displacement relative to the surface.

2. A sensor system as recited in claim 1 wherein the at least one light source is three light sources for directing three light beams along three beam paths.

3. A sensor system as recited in claim 1 wherein the operating and receiving means comprise at least one light detector.

4. A sensor system as recited in claim 3 wherein the at least one light detector is three light detectors.

5. A sensor system as recited in claim 3 wherein the receiving means mixes an outgoing light signal with a reflected signal on each beam path to determine a frequency difference for each beam path.

6. A sensor system as recited in claim 5 wherein the measured distances between the surface and the sensor for each beam path are used by the processing means to calculate an orientation of the sensor system relative to the surface.

7. A sensor system as recited in claim 5 wherein the frequency differences and angle of incidence are used by the processing means to calculate a velocity for each beam path relative to the surface.

8. A sensor system as recited in claim 1 wherein the at least one light source for directing a plurality of light beams is at least one laser source for directing a plurality of laser beams.

9. A sensor system as recited in claim 1 wherein the sensor further comprises a transmitter for transmitting a wireless signal including information generated by the processing means.

10. A sensor system for calculating a displacement of a sensor relative to a surface, the sensor system comprising:
at least one light source for directing a plurality of outgoing light beams along a plurality of respective beam paths toward the surface for reflection therefrom to create a plurality of incoming beams;
a structural member for maintaining a spatial relationship between the beam paths substantially constant;
at least one detector for receiving the plurality of incoming beams;
a mixer coupled with the detector for combining an outgoing light beam with an incoming light beam for at least one beam path to determine a respective frequency difference between the incoming and outgoing light beams; and
a processor coupled with the detector to calculate a respective distance between the surface and the sensor for each beam path and use the frequency difference and calculated distance to determine a velocity between the surface and the sensor, said processor configured to integrate the velocity to determine a displacement of the sensor relative to a surface.

11. A sensor system as recited in claim 10 wherein the at least one light source is three light sources for directing three light beams along three beam paths.

12. A sensor system as recited in claim 11 wherein the at least one light detector is three light detectors.

13. A sensor system as recited in claim 12 wherein a mixer is coupled with each detector for combining an outgoing light beam with an incoming light beam for each beam path to determine a respective frequency difference between the incoming and outgoing light beams on each beam path.

14. A sensor system as recited in claim 13 wherein the three light sources are three laser sources.

15. A sensor system as recited in claim 14 wherein the sensor further comprises a transmitter for transmitting a wireless signal including information generated by the processing means.

16. A method for calculating a displacement of an object relative to a surface, the method comprising the steps of:
attaching a light unit to the object for movement therewith, the light unit configured to generate a plurality of light beams along a plurality of respective beam paths, the beam paths being maintained at a constant spatial relationship relative to each other;
receiving light reflected from the surface along each beam path;
using the received light to measure a respective distance between the surface and the light unit for each beam path; and
analyzing the received light for each beam path to determine a respective velocity between the surface and the sensor for each beam path; and
processing the velocities and the distances to calculate a displacement of the object relative to the surface.

17. A method as recited in claim 16 wherein the plurality of light beams is three laser light beams.

18. A method as recited in claim 16 wherein the object is selected from a group consisting of an individual, a vehicle, a robot or a conveyance.

19. A method as recited in claim 18 wherein the individual is wearing a boot and the light unit is attached to the boot.

20. A method as recited in claim 16 further comprising the step of transmitting a wireless signal including information generated during the processing step.
